(19) United States
(12) Patent Application Publication
(10) Pub. No.: US 2004/0046640 A1
(43) Pub. Date: Mar. 11, 2004

(54) Device for automated control of an electrical device

(76) Inventors: Daniel Jourdain, Saint Agnes (FR); Roland Airiau, Sassenage (FR); Pascal Cerruti, Meylan (FR); Jean-Jacques Damlamian, Clamart (FR); Bruno Graff, La Rochelle (FR)

Correspondence Address: YOUNG & THOMPSON, 745 SOUTH 23RD STREET 2ND FLOOR, ARLINGTON, VA, 22202

(21) Appl. No.: 10/236,963

(22) Filed: Sep. 9, 2002

(51) Int. Cl. H04Q 1/00; G05B 19/00

(52) U.S. Cl. 340/5.64; 340/5.72

(57) ABSTRACT

A device includes a common personal object and/or clothing item (1) worn by a person, containing data characterizing the person and first communication elements adapted to transmit a control signal including the characteristic data and second communication elements provided in the electrical equipment adapted to retrieve the person's characteristic data and control the equipment in accordance with the characteristic data. This invention is applicable to automated control of an electrical equipment.

The present invention relates to a device for automated control of an electrical device by a person.

The invention is, in a very general way, applicable to the field of data transfer, and particularly to man-machine interfaces. A more specific field of application of the invention relates to automated control of an electric equipment activating the triggering of actions related to operation of such equipment, such as for example putting it into or out of operation.

Hereinafter in the present description, the term “electrical equipment” should be understood as any electronic, computer, home automation, multimedia or telecommunication device, or other.

At present, the majority of electric equipments, of domestic type for example, can be equipped with an external control actuated by any user (except when protected by code), or by a control related to time-operation. However, few of them are controlled by the physical presence of a data which is a characteristic, such as an identifying information, specific to a given person.

Previously known techniques have the drawback that, at the time of setting the electrical equipment into operation, even in a standby situation, a voluntary action is needed, which then leaves total freedom to the user (except in case of a new action subject to dialling a code), and which then is put out of operation by switching out the energy source, the system being generally independent of the user person. In particular, remote controls do not permit to recognize the user and to restrict by previous programming the use of the equipment to given periods or time durations as well as for precise functions.

So, the technical problem to be solved by the present invention is to propose a device for automated control of an electrical equipment by a person, which notably permits to be able to control in a personalized manner the programming of the electrical equipment by the mere presence of the user in a given area and during a predetermined period.

The solution to that technical problem consists, according to the present invention, in that the device comprises, on the one hand, a customary or conventional personal unit or a garment held by the person, containing data which are characteristic of said person and first communication means able to provide a control signal including said characteristic data, on the other hand, second communication means installed in said electrical equipment and able to extract data characteristic of the person and to control said equipment according to said characteristic data.

As a result, the automated control device according to the invention has in particular the effect to use, out of the scope of its normal destination, a small personal device such as a watch, a ring, an armband, a pin, so that it can be used as a pre-programmed interface of the electrical equipment.

Two modes of implementation of the invention can be contemplated.

According to a first mode, said equipment is controlled by the mere presence of the personal device in a predetermined area, said control signal being permanently produced. Control is done in the absence of any voluntary and positive action, that is to say, in some respect in a manner by which the person is not really conscious that such control is being performed.

According to a second mode, the control signal is transmitted by an action on the personal device. In that case, the control is done through a is voluntary action of the person. In that case, the personal device incorporates control functions of said second communication means by pressing a button, by selecting an icon on a screen, and/or by voice recognition.

In an advantageous manner, the invention provides that the first and/or second communications means are realized by a low power short distance non-wired connexion, in order to avoid consumption problems or the necessity to have to frequently change or recharge the energy source. Said non-wired connexion is for instance of the radio link type.

In addition, it has to be stressed that the device according to the invention encompasses a great number of controls which can be automated, since it is contemplated that said characteristic data may concern the use, the setting into operation, the unlocking of a key, the stop or the restriction in use, the transmission of messages, the setting into a specific operating mode of the equipment as a function of the person.

Another particularly advantageous feature of the invention consists in that said control between the personal device and the electrical equipment is bi-directional.

This latter characteristic permits to the personal device to receive various data from the electrical device, such as acknowledgment, updating information (in particular identifying information), a renewal of the keys, . . . .

In addition, when according to the invention, the electrical equipment consists of another personal device, possibly identical, persons belonging to a same group, children for instance, can exchange data between themselves by a simple action on their personal device such as a watch.

Moreover, the invention advantageously proposes that the personal device comprises a memory for stocking personal data relating to the person bearing such device, said personal data being able to be read by and/or transmitted to the electrical equipment. The personal device, such as a watch, is then considered as a data bank to which the electrical equipment, a mobile telephone or an electronic personal digital assistant for instance, can access by means of the first and second communications means, radio link for example. These personal data which are stored can then be read by other persons, or transmitted in the case of a bi-directional link, without the necessity for the holder of the personal device to provoke any action.

The following description, given by way of example and in relation with the annexed drawing, will permit a better understanding of the invention and of the manner in which it can be realized.

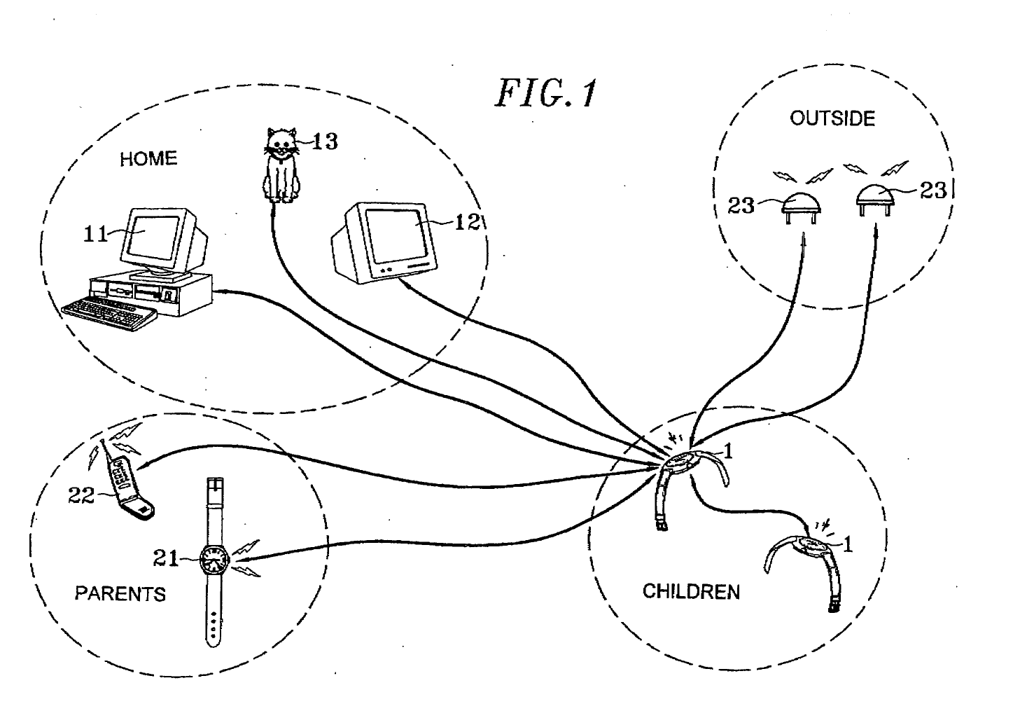

FIG. 1 is a synoptic sketch of an automated control device according to the invention.

On FIG. 1 is shown a device for automated control of an electrical equipment by a person, such as a child for example, actuated upon the wear of a usual personal device and/or cloth 1 of such person, such as an icon type watch, analogue or needle watch, ring, armband, collar, pin, etc.

Electrical equipments which can be controlled by said person are, in a general manner, devices of the type such as electronic, computer, home automation, multimedia, telecommunications or other. On FIG. 1 have been indicated a certain number of examples of electrical devices of the type belonging to the environment of a child, taken as the person who will exert, by means of the personal device 1, control actions on such devices.

In the “children” environment, the personal device is represented by a watch borne by a child. It has to be noted that on FIG. 1, the electrical equipment controlled by the device 1 is not only a device of different nature, but can be another personal device, in the present instance a watch borne by another child of the same family, of the same school, . . . .

In this context, which has not to be considered as having a limiting character, it can be in a general manner considered that the control action from a personal device to another can be bi-directional. In such a way, it becomes possible to children to exchange data by way of links for example, by a single action on their respective watches or by their mere presence in the same area.

In the “home” environment, personal devices can be toys 13 actuated by batteries (dolls, bears, . . . ), household or computer equipments such as a personal computer 11, a personal assistant or even a television set 12.

In the “parents” environment, said electrical equipments can be a cell phone 22 or a watch 21 equipped with communication means permitting to the parents being remote from their children to keep being in relation with them.

In the “outside” environment, the children are in relation with security equipments such as localisation devices 23.

Whatever the environment which is considered, said personal device 1 is equipped with first communication means, such as a Bluetooth short distance low power wireless radio link connexion. These means are capable of emitting a control signal, permanent or not, present in the application layers or the radio connexion which is used: Bluetooth or other. The control signal includes data which are characteristic of the person, which can be an identifying information of the device (i.e. of the person bearing such device), access and access conditions to the service offered by the electrical equipment. If necessary, the certification of the bearer can be realized by a biometric detector with signature or vocal recognition, finger print or eye iris recognition or other morphologic characteristic with memory/comparison function inside the personal device 1 or the equipment receiver.

The already mentioned characteristic data also concern actions to be made with respect to the electrical equipments, such as use, setting into operation, unblocking of a key, restriction of use or interruption of operation, transmission of messages (receiving message, acknowledgement of receipt towards device 1, alert hooter or radio return signal triggering an alarm in device 1, setting into a specific operation mode as a function of the person-choice of channel, of an application of a software program, of a portal or a web site-).

Independently of the applications which are considered, two general operating modes of the device according to the invention are contemplated.

Either the equipment is controlled without the person being positively conscious of such control, due only to the fact of its mere presence in a given area. The control signal is in this situation permanently transmitted.

Or, the control signal is transmitted by a voluntary action on said personal device. In this latter case, the personal device incorporates control functions of said second communication means, such as by pressing a button, selecting an icon on the screen, and/or voice recognition.

In a complementary manner, the device can also comprise a memory for storing personal data related to the person bearing said device. In this case, the memory is considered as a data bank, the content of which can be downloaded in the electrical equipment through the connexion between the first and second communication means when said electrical equipment is activated by the control signal. So, personal data of a watch having a storage memory can be read by and/or transmitted to the electrical equipment which is a mobile telephone or a personal electronic assistant.

In addition, in order to permit the parents for example to control the use by their children of the electrical equipments concerned, it is contemplated that said characteristic data comprise access data limited and/or exclusive to the person bearing the device 1.

On the side of the electrical equipment considered, second communication means are provided, compatible for example with a low power short distance radio connexion of the personal device 1 borne by the person. These second means are capable of extracting from the control signal data characteristic of the person, and controlling the said equipment according to these characteristic data. In particular, the equipment recognizes the identifying information in a given area (from a few meters to several tenths of meters for example) and, if some programmable constraints are respected (hour, duration, distance, . . . ), triggers a series of actions such as previously defined, the programming of which has also been stored. A bi-directional antenna can possibly integrate the azimuth constraint.

The said second communication means of the electrical equipment comprise a receiver which can be internal (series mounted) or external (as an option), and can support the control of the programming (with access by code), receive the outer data by downloading or be preset in a standard manner, and use or not a display system of parameters in order to facilitate programming.

Two applications of the device according to the invention will now be described in details, in the context of the “home” environment of FIG. 1.

A first application concerns the automated control of a computer 11 and its software programs, from the conventional personal device 1.

In the known state of the art, important data exchanges are provided by a connexion of the Bluetooth type, or other, between a personal computer and its peripherals. However, there is no provision for the automatic recognition of a user, the system configuration, the access (limited and/or exclusive) to software programs, or the interruption of operation of the computer when the operator leaves. The computers are generally set “on” or “off” by a key, their configuration and software access being programmed according to a code, and the standby situation being delayed. Automatic access, compulsory or limited (secured access), of a precise user is not performed.

In this application, the small device 1 personal or conventional garment, is used as an interface with pre-programming of the computer 11 for putting it into or out of operation, and for having access to such or such application or Internet site, during a defined period or at a given time, with possibly restriction in use and reception of a feedback signal and/or transmission of an operating signal.

On a technical point of view, the aim is to program the computer 11 by the mere presence of the device in a defined perimeter, and possibly during a defined period. The bi-directional connexion between device 1 and computer 11 is realized by a short distance communication means such as low power radio waves (Bluetooth for example).

The device 1, held by the person, produces a permanent identification to control signal. This signal identifies the device, and consequently the holder, and the access to the service. The computer 11 is equipped with a similar connexion which recognises the identifier (in a given perimeter of a few meters for example). And, if some programmable constraints are respected (duration, distance, . . . ), launches a series of actions the programming of which has also been stored (deactivation of the keyboard, activation of specific peripherals, . . . ).

The receiving equipment of the computer 11 can be internal or external, programming (with code access) being performed by the system or by a complement to the system setting the configuration of the accesses, and possibly triggering auto-execution of the opening of a resident software program.

A second application concerns the automated control from a conventional personal device, of a multimedia or of an home automation equipment. The example which has been chosen relates to a television set 12, but it could as well relate to an audio or video system, a game, a household equipment, etc . . . .

Starting of operation of the television set, even when the standby position, requires an action on at least one key of the remote control (or of the television set itself), and leaves then total freedom to the user to choose its program. The presently known remote control devices do not allow the recognition of the user and the restriction by previous programming, of the use of the television set at certain hours, or during predetermined durations, or for accessing precise programs. The filtering aspect for the access is totally unknown.

Personal device 1 or conventional garment is used as pre-programmed interface of an apparatus such as a television set for example to put it into operation for such or such channel, during a defined period of time; or until a predetermined hour.

As previously explained, the purpose is to control programming of the television set 12, or more generally of the device by the mere presence of the device 1 in a defined perimeter or area, and possibly during a defined period. The bi-directional connexion between device 1 and television set 12 is realized by a low power radio waves communication means (Bluetooth or other).

Also in that case, the device 1 (ring, watch, armband, pin) provides a permanent control identifying signal. The signal identifies the device itself and the access right to the service. The television set 12 is equipped with a similar connexion which recognizes the identifying information (in a perimeter of about ten meters), and, if some programmable constraints are fulfilled (hour, duration, distance, . . . ), triggers a series of actions the programming of which has also been stored. The coding of the emission level can allow some switchings off. The communication means of the television set 12 can be internal or external, support the control of the programming, or receive outer data (remote programming), an can use or not a system of the teletext type to display its parameters or facilitate programming.

An application in the “parents” environment will now be described in details. This application concerns an electrical equipment formed by a communication terminal 22.

To deliver a message to a person via a communication terminal, there exists presently several solutions: a mobile telephone, a pager which sends short messages SMS (Short Message System), GSM watches. Some of these devices have a heavy weight (about one hundred grams) or a too weak autonomy (less than one hour for watches). They can therefore not be used by young children. In addition, it does not seem that any filtering is performed depending on the person, nor that the use is adapted to a person, except by introduction of a blocking/unblocking code.

In this application, device 1 provides a control signal triggering the operation, the stop or the automatic restriction in use of the terminal. Device 1, a watch for example, which comprises the user interface, is controlled by pressure on a button, choice of an icon on a screen, or by vocal recognition. The terminal becomes only a telecommunication terminal, by analogy with a modem.

A small personal device 1, or a usual garment is used as a preprogrammed interface of a communication terminal 22, to send a programmed message to a remote person.

On a technical point of view, there is provided a shift of the user-interface function from the long distance communication function related to a dedicated terminal 22 of the mobile telephone type (GSM, GPRS or UMTS). The bi-directional connexion between device 1 and terminal 22 being realized by a short distance communication means such as low power radio waves (for example Bluetooth).

In the environment of device 1 borne by a person, at about several tenths of meters is situated a terminal 22 of the GSM type (or GPRS, UMTS . . . ), such terminal being simplified in the sense that it may have no keyboard, no screen, no microphone or no listening means, such terminal providing for the long distance connexion with remote scheduled persons, addressees of a message transmitted by the terminal. By an action on the device (pressure, sound, . . . ), a transmission of the message (which has been possibly pre-programmed) is realized with one or several of said scheduled persons: short message SMS, registered message, music, or icon which can be with or without animation, or short scene.

Another application related to the “parents” environment concerns the use of a watch 21 which can be considered as an electrical equipment controlled by the personal device 1, or also as a personal device controlling the electrical equipment formed by device 1. In accordance with the bi-directional character of the control, watch 21 of the parents can remotely send a request to watch 1 borne by a child, in order to be able for example to get knowledge of the information contained in watch 1, such as the lunch menu taken at school by the child, or any other information concerning the child and his activities.

An application of the device in the “outside” environment will now be described in details. This application concerns the localization of a personal customary personal device by a communication terminal, or by several communication terminals 23 organized in network.

In this application, a control/identification signal is provided by device 1, provoking its retransmission by a unique terminal, equipped with a bi-directional antenna, or having measuring means of the received power, or disposing of a network permitting a (triangulation), with possible return of an acknowledgment of receipt signal.

The small personal device 1 or usual garment is used as an emitting device of a signal permitting precise localization in the open context of a park, or in the closed context of a room, or various gathering places having at their disposal a network of reception terminals 23. The bi-directional connexion between device 1 and terminals 23 of the network is realised by a communication means such as low power radio waves (Bluetooth).

It can also be considered to exceptionally use the emission of the signal, for localization purpose by a receiver (installed in a helicopter for instance) thus permitting a strong signal amplification in the context of a little inhabited zone (forests, hills, . . . ).

On a technical point of view, in the environment of device 1 borne by the person, there are provided every ten meter receiving terminals 23, which relay the identifying signal, either by GSM, or by a physically linked network (cables, electrical network notably) towards a central station which stores the initial signal of device 1 and the signal of terminals 23. On demand, the cross examination of several data and the localization of device 1 can be done and returned to the applicant. Out of the context of numerous radio emissions, the localization can be done by a bi-directional antenna and an amplifier which can be a high power amplifier, in the receiver.

1. Device for automated control of an electrical equipment by a person, characterised in that the device comprises, on the one hand, a customary or conventional personal device (1) or a garment held by the person, containing data which are characteristic of said person and first communication means able to provide a control signal including said characteristic data, and on the other hand, second communications means installed in said electrical equipment and able to extract the data characteristic of the person and to control said equipment according to said characteristic data.

2. Device as claimed in claim 1, characterised in that said electrical equipment is an electronic, or a computer or a home automation or a multimedia or a telecommunication device.

3. Device as claimed in claim 1 or claim 2, characterized in that the control between the personal device (1) and the electrical equipment is bi-directional.

4. Device as claimed in any of claims 1 to 3, characterized in that said equipment is controlled by the mere presence of the personal device (1) in a defined area, said control signal being permanently produced.

5. Device as claimed in any of claims 1 to 3, characterized in that said control signal is produced by means of an action on said personal device (1).

6. Device as claimed in claim 5, characterized in that said personal device (1) includes control functions of said second communication means, within the following list: pressure of a button, choice of an icon on a screen, voice recognition.

7. Device as claimed in any of claims 1 to 6, characterized in that said personal device (1) is a device belonging to the following list: an icon watch, an analogue watch, a needle watch, a ring, an armband, a collar, a pin.

8. Device as claimed in any of claims 1 to 7, characterized in that said characteristic data concern, separately or in combination, the use, the setting into operation, the unlocking of a key, the interruption or the restriction in use, the transmission of messages, the setting into a specific operating mode as a function of the person.

9. Device as claimed in any of claims 1 to 8, characterized in that said first and/or second communication means are realized by a non wired low power short distance connexion.

10. Device as claimed in any of claims 1 to 9, characterized in that the second communication means are adapted to transmit to the first communication means an acknowledgment of receipt signal.

11. Device as claimed in any of claims 1 to 10, characterized in that said characteristic data comprise limited and/or exclusive access data related to the person.

12. Device as claimed in claim 11, characterized in that said limited and/or exclusive access data related to the person are validated or certified by biometric recognition.

13. Device as claimed in claim 12, characterized in that said biometric recognition consists of a signature or a voice recognition, a finger or eye print, with memory/comparison function in the personal device (1) or in the communication means of the electrical equipment.

14. Device as claimed in any of claims 1 to 13, characterized in that said electrical equipment is constituted by another personal device.

15. Device as claimed in any of claims 1 to 14, characterized in that the personal device (1) comprises a storage memory for storing the personal information data relating to the person bearing said personal device (1), said personal information data being arranged to be read by and/or communicated to the electrical equipment.

16. Application of the device as claimed in any of claims 1 to 15, characterized in that said electrical equipment is formed of a communication terminal, fixed or mobile.

17. Application as claimed in claim 16, characterized in that said communication terminal comprises mobile telephony functions.

18. Application of the device as claimed in any of claims 1 to 15, characterized in that said electrical terminal is formed of a computer (11).

19. Application of the device as claimed in any of claims 1 to 15, characterized in that said electrical terminal is formed of an audiovisual apparatus.

20. Application as claimed in claim 19, characterized in that said characteristic data comprise the period of setting on the device and/or of limited access to certain channels, stations, applications or functions.

21. Application of the device as claimed in any of claims 1 to 15, to the localization of the personal device

22. Article for a device for automated control of an electrical equipment by a person, characterized in that said article (1) is a usual or customary personal device (1) or a garment borne by said person, containing data which are characteristic of said person, and first communication means capable of providing a control signal including said characteristic data.

23. Article as claimed in claim 22, characterized in that is it constituted by an icon watch (1), or an analogue watch, or a needle watch, or a ring, or an armband, or a collar or a pin.

24. Article as claimed in claim 22 or claim 23, characterized in that said characteristic data concern, separately or in combination, the use, the setting into operation, the unlocking of a key, the interruption or the restriction in use, the transmission of messages, the setting into a specific operating mode as a function of the person.

25. Article as claimed in any of claims 22 to 24, characterized in that the personal device (1) further comprises a storage memory which contains the personal information data relating to the person.

26. Electrical equipment arranged to be controlled by a person bearing an article (1) as claimed in claims 22 to 25, characterized in that it comprises the second communication means arranged to extract the data which are characteristic of the person and to control said equipment in accordance with said characteristic data.

27. Electrical equipment as claimed in claim 26, characterized in that it is formed by an electronic, or a computer or a home automation or a multimedia or a telecommunication device.

28. Electrical equipment as claimed in any of claims 26 or 27, characterized in that the second communication means are adapted to transmit an acknowledgement of receipt signal towards the first communication means.
